(19) United States
(12) Patent Application Publication
(10) Pub. No.: US 2025/0362165 A1
(43) Pub. Date: Nov. 27, 2025

(54) NON-CONTACT TYPE WATER LEVEL DETECTION AND MANAGEMENT METHOD AND ELECTRONIC EQUIPMENT THEREOF

(71) Applicant: Shenzhen Beibanqiu Network Technology Co., Ltd., Shenzhen (CN)

(72) Inventors: Zhu MING, Shenzhen (CN); Huawen MA, Shenzhen (CN); Jiujun ZHOU, Shenzhen (CN)

(73) Assignee: Shenzhen Beibanqiu Network Technology Co., Ltd., Shenzhen (CN)

(21) Appl. No.: 19/290,277

(22) Filed: Aug. 4, 2025

(30) Foreign Application Priority Data
Jun. 30, 2025 (CN) 202510900489.6

(51) Int. Cl. G01F 23/26; A01K 7/02; G01F 25/20

(52) U.S. Cl. CPC G01F 23/261; A01K 7/02; G01F 25/20

(57) ABSTRACT

The invention provides a non-contact type water level detection and management method, comprising: obtaining a reference capacitance value of a target pet water dispenser in a waterless state; collecting a real-time detection capacitance value in water of the pet water dispenser at preset intervals during regular operation of the pet water dispenser; comparing the reference capacitance value with the real-time detection capacitance value in water to determine a current water level state in the water dispenser; and controlling and managing an operation state of a water pump in the pet water dispenser based on the water level state. By using a no-load calibration value as a reference datum in combination with periodic detection, the invention can accurately distinguish between watery and waterless states, improve the accuracy of water level judgment, effectively avoid false triggering of water pump operation, and has the advantages of simple structure, low cost, and strong applicability.

### RELATED APPLICATIONS

The present patent document claims the benefit of priority to Patent Application No. 202510900489.6, filed Jun. 30, 2025, and entitled “NON-CONTACT TYPE WATER LEVEL DETECTION AND MANAGEMENT METHOD AND ELECTRONIC EQUIPMENT THEREOF,” the entire contents of each of which are incorporated herein by reference.

### BACKGROUND

### 1. Technical Field

The present invention relates the field of intelligent detection, and in particularly to a non-contact type water level detection and management method, a device, an electronic equipment and a storage medium thereof.

### 2. Background Information

At present, pet water dispensers generally employ electrode or capacitive water level detection methods to achieve automatic water supply and water pump control. However, the existing technologies generally suffer from the following issues.

On one hand, a capacitive detection structure typically needs to be potted and sealed between a sensor and a plastic water tank, so as to ensure stability of the sensor detection values. However, this potting process not only increases manufacturing costs and production cycles but also brings inconvenience to later maintenance. On the other hand, most existing water level detection solutions are based on fixed thresholds or analog comparators to directly determine whether capacitance values reach water level standards, which is easy to be misjudged due to factors such as capacitance drifts and environmental changes, leading to frequent start and stop of water pumps, thereby reducing system stability and lifespan.

In addition, although some solutions support capacitance calibrations, they typically rely on manually adjusting potentiometers or manually configuring parameters, making them difficult to adapt to the needs of large-scale automated production. Moreover, they lack integrated embedded control capabilities.

Therefore, there is a need for a non-contact type water level detection and management method that eliminates the reliance on potting structures, can automatically collect reference values and perform dynamic comparison processing, and achieves high stability, low-cost, and intelligent pump control, so as to overcome the aforementioned defects in the existing technology.

### BRIEF SUMMARY

The embodiment of the present invention provides a non-contact type water level detection and management method to solve the problem that the existing non-contact type water level detection and management method relies on the potting structure and cannot automatically collect reference values and perform dynamic comparison processing to detect water level states of devices and perform water level managements.

In a first aspect, the embodiment of the present invention provides a non-contact type water level detection and management method, which comprises the following steps:
obtaining a reference capacitance value of a target pet water dispenser in a waterless state;
collecting a real-time detection capacitance value in water of the target pet water dispenser at preset intervals during regular operation of the target pet water dispenser;
comparing the reference capacitance value with the real-time detection capacitance value in water to determine a current water level state in the target water dispenser; and
controlling and managing an operation state of a water pump in the target pet water dispenser based on the water level state.

Optionally, obtaining a reference capacitance value of a target pet water dispenser in a waterless state includes:
grounding a preset test contact before the target pet water dispenser is powered up for the first time; and collecting a water capacitance value of the target pet water dispenser in the waterless state; and
storing the water capacitance value of the target pet water dispenser in the waterless state as the reference capacitance value.

Optionally, before collecting a real-time detection capacitance value in water of the target pet water dispenser at preset intervals during regular operation of the target pet water dispenser, the method further comprises:
determining a first preset period based on detection interval data of the target pet water dispenser;
determining a fluctuation state of a water capacitance of the target pet water dispenser, wherein the fluctuation state is used to determine a contact frequency between the water capacitance and a water level;
determining adjustment data of the preset intervals based on the fluctuation state;
adjusting the first preset period based on the adjustment data to obtain a second preset period; and
collecting the real-time detection capacitance value in water of the target pet water dispenser according to the second preset period.

Optionally, collecting a real-time detection capacitance value in water of the target pet water dispenser at preset intervals during regular operation of the target pet water dispenser includes:
collecting the real-time capacitance value in water according to time interval data corresponding to the preset intervals when it is detected that the target pet water dispenser operates regularly, and buffering the collected real-time water capacitance value.

Optionally, the water level state includes a watery state and a waterless state; wherein comparing the reference capacitance value with the real-time detection capacitance value in water to determine a current water level state in the target water dispenser include:
calculating differential values between the real-time detection values of the water capacitance and the reference capacitance values in multiple preset periods to obtain multiple capacitance differential values;
determining that the target pet water dispenser is in the watery state when the capacitance differential values in the continuous preset number periods are greater than or equal to the reference capacitance value; and
determining that the target pet water dispenser is in the waterless state when the capacitance differential values in the continuous preset number periods are less than the reference capacitance value.

Optionally, comparing the reference capacitance value with the real-time detection capacitance value in water to determine a current water level state in the target water dispenser further includes:
determining current environmental data of the water capacitance, wherein the environmental data includes temperature data and humidity data;
determining an error adjustment data for the real-time detection capacitance value in water based on the temperature data and the humidity data;
adjusting the real-time detection capacitance value in water based on the error adjustment data to obtain a target real-time detection capacitance value in water; and
comparing the target real-time detection capacitance value in water with the reference capacitance value to obtain the current water level state in the target pet water dispenser.

Optionally, controlling and managing an operation state of a water pump in the target pet water dispenser based on the water level state includes:
controlling the water pump to start operation when the water level state remains in the waterless state for continuous multiple sampling periods; and
controlling the water pump to stop operation when the water level state persists in the watery state for continuous multiple sampling periods.

In a second aspect, the embodiment of the present invention further provides a non-contact type water level detection and management device, which comprises:
a first obtaining module, used for obtaining a reference capacitance value of a target pet water dispenser in a waterless state;
a first collection module, used for collecting a real-time detection capacitance value in water of the target pet water dispenser at preset intervals during regular operation of the target pet water dispenser;
a first determination module, used for comparing the reference capacitance value with the real-time detection capacitance value in water to determine a current water level state in the target water dispenser; and
a first control module, used for controlling and managing an operation state of a water pump in the target pet water dispenser based on the water level state.

In a third aspect, the embodiment of the present invention provides an electronic equipment, which comprises: a memory, a processor, and a computer program stored in the memory and executed by the processor. When the processor executes the computer program, the steps of the non-contact type water level detection and management method provided by an embodiment of the present invention are implemented.

In a fourth aspect, the embodiment of the present invention provides a computer readable storage medium, wherein the computer readable storage medium stores a computer program. When the computer program is executed by a processor, the steps of the non-contact type water level detection and management method provided by the embodiment of the present invention are implemented.

In the embodiment of the present invention, the method comprises: obtaining a reference capacitance value of a target pet water dispenser in a waterless state; collecting a real-time detection capacitance value in water of the target pet water dispenser at preset intervals during regular operation of the target pet water dispenser; comparing the reference capacitance value with the real-time detection capacitance value in water to determine a current water level state in the target water dispenser; and controlling and managing an operation state of a water pump in the target pet water dispenser based on the water level state. By using a no-load calibration value as a reference datum in combination with periodic detection, the invention can accurately distinguish between watery and waterless states, improve the accuracy of water level judgment, effectively avoid false triggering of water pump operation, and has the advantages of simple structure, low cost, and strong applicability.

### BRIEF DESCRIPTION OF THE DRAWINGS

In order to more clearly illustrate the technical solutions in the embodiments of the present invention or the prior art, the accompanying drawings required for describing the embodiments or the prior art will be briefly introduced hereafter. Apparently, the following described drawings are merely a part of the embodiments of the present invention; other drawings can be obtained by those of ordinary skill in the art according to these drawings without any creative works.

FIG. 1 is a flow diagram of a non-contact type water level detection and management method provided by an embodiment of the present invention.

FIG. 2 is a circuit diagram of a non-contact type water level monitoring circuit provided by an embodiment of the present invention.

FIG. 3 is a schematic structural diagram of another non-contact type water level detection and management device provided by the embodiment of the present invention.

FIG. 4 is a schematic structural diagram of electronic equipment provided by an embodiment of the present invention.

### DETAILED DESCRIPTION OF THE DRAWINGS AND THE PRESENTLY PREFERRED EMBODIMENTS

The technical solutions in the embodiments of the present invention will be clearly and completely illustrated below in conjunction with the accompanying drawings of the embodiments of the present invention. Apparently, the described embodiments are merely a part of the embodiments of the present invention, but not all of the embodiments. Based on the embodiments of the present invention, all other embodiments obtained by those of ordinary skill in the art without exerting creative efforts shall fall within the protection scope of the present invention.

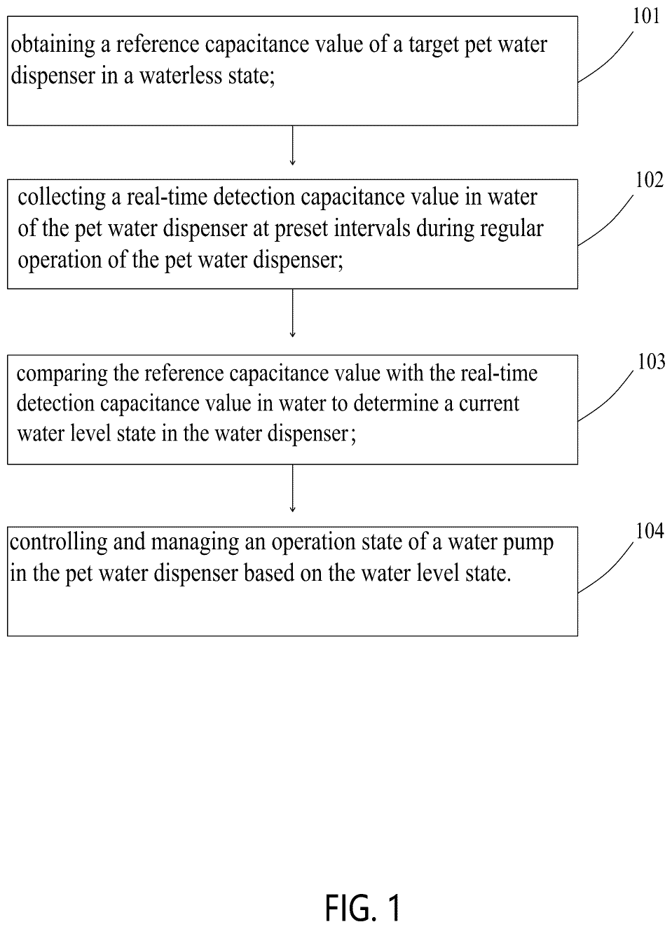

As shown in FIG. 1, FIG. 1 is a flow diagram of a non-contact type water level detection and management method provided by an embodiment of the present invention. The non-contact type water level detection and management method comprises the following steps:

101: obtaining a reference capacitance value of a target pet water dispenser in a waterless state;

In the embodiment of the present invention, the aforementioned non-contact type water level detection and management method can be applied to a non-contact type water level detection and management platform. The aforementioned non-contact type water level detection and management system has the functions of water level data processing, water level data sending and receiving, and water level data memory storage. Moreover, it can be constructed based on servers or server clusters. The above servers or server clusters can be electronic equipment with water level data processing capabilities, such as pet water dispensers equipped with water level detection functions, including both pump-type and self-filling water dispensers.

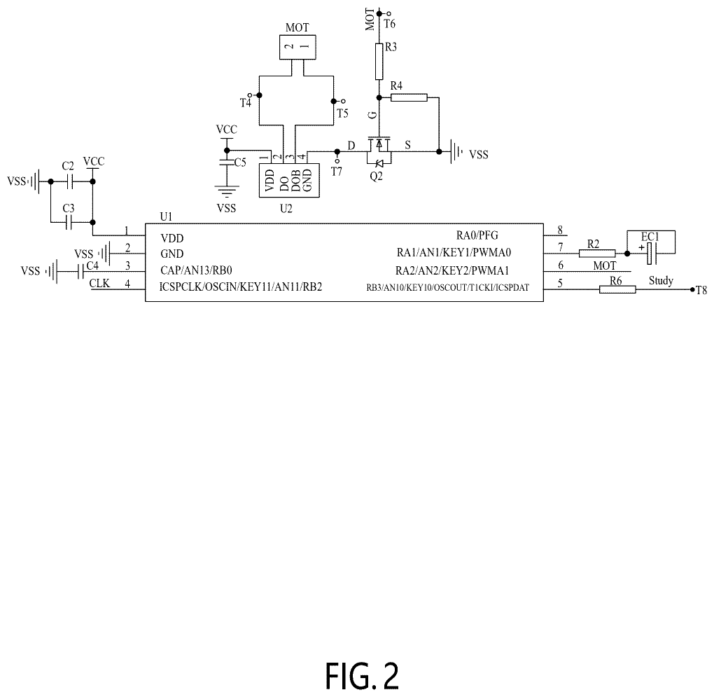

The aforementioned target pet water dispenser can be an object device to which the present invention is applied, specifically including household pet water dispensers or automatic water replenishment apparatus. The device or apparatus comprises at least one non-contact type water level detection circuit, which can be illustrated by the circuit diagram shown in FIG. 2. The diagram comprises: \textcircled{1} water detection control chip U1, \textcircled{2} water pump motor drive chip U2, \textcircled{3} water detection capacitor EC1, \textcircled{4} water detection sensitivity adjustment capacitor C4, \textcircled{5} filter capacitors C2, C3, C5, \textcircled{6} current-limiting resistors R3, R4, R6, R2, \textcircled{7} motor coil MOT, and \textcircled{8} calibration test point T8.

More specifically, the aforementioned reference capacitance value can be obtained through the aforementioned circuit. For example, after the target pet water dispenser is assembled but not yet placed in water, grounding the T8 through a production fixture before powering on the device. Upon power-up, the U1 enters a calibration mode and writes the calibrated values to an EEPROM, then the T8 is disconnected, and the target pet water dispenser enters a regular operation mode. During production, grounding the T8 enables one-time calibration and writes data to the EEPROM. This ΔC water-level detection method eliminates the need for potting while maintaining long-term moisture resistance.

In the circuit diagram shown in FIG. 2, a positive terminal of an electrode EC1 is connected to a power supply, and linked to pins (RA1/KEY1/PWMAO) of a microcontroller via the current-limiting resistor (R2). When the water level rises to cover the electrode, the water forms a conductive path, and a micro-current flows into an I/O port (current-limited by R2) of the microcontroller. If the water is not in contact with the electrode, the I/O port remains in a high-resistance state, which is read as a logical high level (indicating no water); otherwise, it reads as a low level (indicating water presence). In this way, the purpose of using the conductivity of the water for on/off detection can be achieved by low-cost and without requiring special water-level sensors.

In the motor drive control section of FIG. 2, the U2 can be a logic control module, and the control signal comes from the microcontroller U1, the control signal is for driving a gate (G) of Q2. Through the current-limiting resistor R4, the Q2 is configured as an N-channel power MOSFET (such as IRF540), with its source (S) grounded and drain (D) connected to both the motor and power supply. One end of the motor is connected to VCC and the other end is connected to the drain (D) of the MOSFET. When the MOSFET conducts, a closed circuit is formed, and the motor operates. The Q2 includes a flyback diode to protect the MOSFET from inductive voltage spikes generated when the motor is switched off.

Specifically, the circuit control logic can be designed as follows: when the electrode EC1 detects that the water level reaches the set value, the microcontroller reads a low level at the IO port, the microcontroller then sends a control signal to U2 to drive the MOSFET Q2 to turn on, and the motor (MOT) starts and performs operations such as draining or filling water; once the water level changes, the state of the EC1 changes accordingly, and the microcontroller subsequently shuts off the motor.

The aforementioned “waterless state” refers to the state in which the detection area of the target pet water dispenser is not covered by water or the detection electrode is not in contact with liquid before calibration or detection. This state can represent a no-load environment of the corresponding sensor in the “air medium”.

The aforementioned reference capacitance value may be capacitance value data collected by the target pet water dispenser in the “waterless state”, which represents “no-load capacitance characteristics” of a device sensor under its current structural assembly conditions. Specifically, the aforementioned reference capacitance value can be written into an internal memory (e.g., EEPROM) after being detected by the control chip, used for a comparative baseline for determining real-time water levels in subsequent operations. For example, after the target pet water dispenser enters the production calibration mode, the control chip triggers the capacitance detection module to collect the current capacitance value of the electrode EC1 (e.g., 30.2 pF) and stores this value in the EEPROM. In the subsequent operation, if the real-time collection value rises to 45.8 pF, it is determined as the “watery state”; otherwise, the “waterless state” judgment is maintained.

In one possible embodiment, before the target pet water dispenser is powered on for the first time, the control chip is triggered to enter the calibration mode by grounding the preset test contact (e.g., a production test pin T8). The control chip controls a capacitance acquisition module to sample a capacitance value of the sensor in the current waterless state, and stores the capacitance value in the EEPROM as a reference value for subsequent water level judgments. After the calibration process is completed, the device disconnects the test contact, automatically exits the calibration mode, and enters the regular operation state. During subsequent use, the control chip will periodically collect real-time water capacitance values and compares them with the aforementioned reference value to determine whether there is water at present, thereby achieving precise control of start and stop of the water pump.

102: collecting a real-time detection capacitance value in water of the target pet water dispenser at preset intervals during regular operation of the target pet water dispenser;

In the embodiment of the present invention, the aforementioned regular operation process refers to a stable working phase of the target pet water dispenser after being put into actual use by users under non-testing and non-calibration conditions, where the device is continuously powered, the sensor is in an enabled state, and the control chip performs the water level detection and water pump control program. Typically, this refers to the operation state after the device is powered on for the first time post-production. Refers to a stable working stage that

The aforementioned preset intervals can be a fixed time interval parameter configured by the control chip, and this parameter is used to periodically schedule and perform the water capacitance detection task to ensure the continuity and real-time performance of the water level detection. Typically, the sampling period interrupt is set by an MCU internal timer (such as Timer0), or the period scheduling is completed by using a soft timer under the RTOS. The period value can be hardcoded in the program, and can also be configured as an adjustable parameter in the EEPROM. For example, by setting a Timer1 to 1000 ms, the control chip triggers capacitance detections every second, thereby achieving a timed detection at a frequency of 1 Hz, ensuring that the water level state is updated within once per second.

In one possible embodiment, the detection electrode (such as EC1) can be sampled in real time through a capacitance detection module or an analog front-end circuit, so as to obtain the capacitance value at this time. Typically, a single collection includes electrode activation, signal stabilization, reading and converting the result, temporary storage in variables or registers, and other steps. The collection time typically ranges from tens of microseconds to several milliseconds. It should be understood that the control chip triggers the acquisition process once per second, and performs a capacitive sampling on the C_pad of the detection electrode. If a sampled value is, for example, 46.8 pF, it is then stored in an RAM for comparison with the reference value.

The real-time detection capacitance value in water can be a capacitance value collected by a capacitive sensor in the target pet water dispenser at specific time point, which reflects the dielectric environment state of the sensing area at that moment and can be used to determine the water level states. It should be understood that, since the real-time detection capacitance value in water will fluctuate due to external factors such as liquid level height, water quality variation, temperature, humidity, or even the proximity of a finger, the error value can be judged by combining the reference value with an anti-shake mechanism. For example, if the reference value is 30.5 pF and the current real-time detection value is 47.0 pF, the difference of 16.5 pF exceeds a set threshold of 10 pF. In this case, the current state is determined as “watery state”.

In another possible embodiment, the target pet water dispenser enters regular operation after completing initial power-on and reference capacitance value calibration. During this operation state, the control chip (e.g., an MCU) triggers a detection task at preset periodic intervals as programmed. When each period arrives, the control chip will sample a capacitance signal of the detection electrode (EC1) through an internal sampling pin or capacitance detection channel to obtain the real-time detection capacitance value in water.

103: comparing the reference capacitance value with the real-time detection capacitance value in water to determine a current water level state in the target water dispenser;

In the embodiment of the present invention, the control chip calculates a difference between the real-time detection capacitance value in water collected at present and the reference value of the water capacitance stored during initialization, and compares this difference with a preset threshold value, so as to determine whether the current water level has changed, thereby achieve the purpose of comparison processing.

Specifically, when the device is first powered on, the calibration is triggered via a test pin to collect the capacitance value in a waterless state (e.g., 31.2 pF), and this value is stored in the EEPROM as a reference capacitance value. During regular operation, the real-time capacitance value (such as 46.5 pF) is collected every second. And the difference =Real-time value-Reference value=15.3 pF is calculated to compare with the preset threshold (such as 10 pF). If the ΔC is equal to or greater than the preset threshold, it is determined as a watery state; if the ΔC is lower than the preset threshold, it is determined as a waterless state.

The aforementioned control chip may be implemented as a combined control circuit composed of the microcontroller U1 and/or microcontroller U2 in the circuit diagram shown in FIG. 2.

The aforementioned water level states can be based on the result of comparison processing, which indicates a binary judgment result of whether there is liquid (water body) in the current target pet water dispenser. It typically yields one of two states: “watery state” or “waterless state”.

In one possible embodiment, during regular operation of the device, the real-time detection values of the water capacitance will be periodically collected. A comparative processing method is used to determine whether there is water. In the embodiment, a differential value calculation method can be used, and ΔC is used as the differential value, wherein:
the real-time detection capacitance value in water is the current capacitance value obtained from each periodic sampling;
the reference capacitance value is the no-load capacitance value of the device in the waterless state; and
ΔC represents a deviation of the current detected value relative to the reference value.

Finally, this deviation is compared with a set threshold. For example, if the ΔC>10 pF, it is determined that water is present; if the ΔC<10 pF, it is considered that no water is detected.

104: controlling and managing an operation state of a water pump in the target pet water dispenser based on the water level state.

In the embodiment of the present invention, the target pet water dispenser judges the current water level state in real time through periodic water capacitance detection and comparison processing. When a waterless state is detected, the control chip issues a command to activate the water pump for automatic water replenishment. Conversely, when a watery state is detected, the control chip controls the water pump remain closed to prevent redundant refilling or idle operation.

Specifically, the start and stop of the water pump can be performed by the following steps:

If the water level state is the “waterless state”, and the water pump is not running currently, the control chip outputs a high-level to a pump drive module (such as a MOS tube or relay) to start the water pump.

Set a soft timer (e.g., for a maximum running time of 20 seconds);

If the water level state is the “watery state” and the water pump is currently running, the control chip outputs a low-level signal to stop the water pump.

Clear the software timer.

In the embodiment of the present invention, the method comprises: obtaining a reference capacitance value of a target pet water dispenser in a waterless state; collecting a real-time detection capacitance value in water of the target pet water dispenser at preset intervals during regular operation of the target pet water dispenser; comparing the reference capacitance value with the real-time detection capacitance value in water to determine a current water level state in the target water dispenser; and controlling and managing an operation state of a water pump in the target pet water dispenser based on the water level state. By using a no-load calibration value as a reference datum in combination with periodic detection, the invention can accurately distinguish between watery and waterless states, improve the accuracy of water level judgment, effectively avoid false triggering of water pump operation, and has the advantages of simple structure, low cost, and strong applicability.

Optionally, in the step of obtaining a reference capacitance value of a target pet water dispenser in a waterless state, the method further comprises: grounding a preset test contact before the target pet water dispenser is powered up for the first time; and collecting a water capacitance value of the target pet water dispenser in the waterless state; and storing the water capacitance value of the target pet water dispenser in the waterless state as the reference capacitance value.

In the embodiments of the present invention, the preset test contact may be an external pin designed for production testing or initialization configuration, which is typically connected to one of I/O ports of the control chip, and does not interact with the user during regular use of the device. For example, it can be a grounding pin T8 as shown in the circuit diagram of FIG. 2. The pin can be designed on a PCB as gold fingers, solder pads, or test points for fixture contact, facilitating grounding operations by production line tooling (such as probe fixtures).

When the test contact is grounded, the control chip reads the pin as a low level when it is first energized, thereby identifying that the device is currently in “factory calibration mode”. At this time, the device has not been injected with water and is in the waterless state. The detection electrode (such as EC1) is surrounded by air, and the capacitance value represents a no-load state.

At this time, the control chip initiates a capacitance sampling routine, that is, collects the capacitance value detected by the current sensor electrode (for example: 31.8 pF), which is the reference capacitance value of the device itself in the waterless state. Upon completion of sampling, this capacitance value will be written into a memory of the control chip for the reference of water level judgment during subsequent operation.

Optionally, in the step of, before collecting a real-time detection capacitance value in water of the target pet water dispenser at preset intervals during regular operation of the target pet water dispenser, the method further comprises: determining a first preset period based on detection interval data of the target pet water dispenser; determining a fluctuation state of a water capacitance of the target pet water dispenser, wherein the fluctuation state is used to determine a contact frequency between the water capacitance and a water level; determining adjustment data of the preset intervals based on the fluctuation state; adjusting the first preset period based on the adjustment data to obtain a second preset period; and collecting the real-time detection capacitance value in water of the target pet water dispenser according to the second preset period.

In the embodiment of the present invention, the aforementioned detection interval data may refer to a difference (i.e., variation) between each pair of adjacent capacitance values obtained during multiple consecutive real-time water capacitance detection, which is used to evaluate fluctuation characteristics of the capacitance signal over a certain period. Typically, N real-time capacitance values can be continuously collected by setting a window length N (e.g., 5 detection points), and the differences between every two consecutive values can be calculated to form an interval data sequence.

The aforementioned fluctuation state can be used to determine the contact frequency between the water capacitance and the water level. Typically, it refers to continuous, small amplitude and two-way fluctuations of the water capacitance detection value in a short time, indicating that the sensor is in an unstable state. This typically occurs near the critical water level and highly sensitive zone or may be caused by factors such as air bubbles, vibrations, electromagnetic interference, etc. By analyzing the fluctuation state, unstable factors like air bubbles, vibrations, or critical water-level conditions can be excluded when determining the “watery” or “waterless” states.

Specifically, it can be determined using the following algorithm:
for 3 to 5 consecutive detection intervals (differences):
all values are less than the set minor fluctuation threshold (e.g., ±1.0 pF);
the fluctuation directions are inconsistent; and
then, it is judged as the “fluctuation state”.

The first preset period may be a time interval of the water capacitance sampling period set by the target pet water dispenser in a default or start-up phase, and its unit is milliseconds. It represents the basic sampling frequency that has not been used before the fluctuation analysis.

The adjustment data can be controlling parameters generated based on the current detection state (whether fluctuation occurs), used to adjust original sampling period. By confirming the adjustment data, the sampling frequency can be adjusted dynamically to improve the response speed in an unstable state, or save resources in a stable state.

The second preset period may refer to a new sampling period obtained by superimposing or transforming the first preset period with the adjustment data, which is used for dynamic control of subsequent water capacitance collection. Through this dynamic period adjustment mechanism, the system can adaptively adjust the sampling strategy based on actual operating conditions, thereby achieving a balance between detection sensitivity and system load.

In one possible embodiment, after the target pet water dispenser enters the regular operation, a dynamic analysis is performed to determine whether the detection period needs to be adjusted. Specifically, there is a default sampling period in the initial state, called the first preset period, which is used to periodically collect the real-time detection capacitance value in water. Before entering periodic sampling, the trend and interval information of the change of the water capacitance value in the past multiple sampling periods are first read to form detection interval data. The control chip analyzes these interval data to determine the frequency and amplitude of the capacitance value in the continuous periods, so as to determine whether the current capacitance curve presents the fluctuation state. If the fluctuation is detected (e.g., frequent jumps in capacitance values or fluctuations exceeding a micro-threshold), a set of adjustment data, including recommendations to shorten or extend the sampling interval, will be generated based on predefined scheduling logic. Based on this adjustment data, the original first preset period is dynamically adjusted to obtain the second preset period. Subsequently, the water capacitance value collection and judgment operation continue in the next phase according to the second preset period.

Optionally, the step of collecting a real-time detection capacitance value in water of the target pet water dispenser at preset intervals during regular operation of the target pet water dispenser further includes: collecting the real-time capacitance value in water according to time interval data corresponding to the preset intervals when it is detected that the target pet water dispenser operates regularly, and buffering the collected real-time water capacitance value.

In the embodiment of the present invention, after the power-on initialization and reference capacitance value calibration of the target pet water dispenser are completed, it enters the regular operating state and begins to perform the water capacitance detection process based on the preset intervals.

Specifically, after detecting the above-mentioned target pet water dispenser entering the regular operation state, a timing task is started. That is, when each preset time interval arrives, a real-time detection capacitance value in water is collected. The process may include: activating a detection electrode EC1; control an AD converter or a capacitance measurement circuit to obtain the current capacitance value (unit: pico/pF); and writing the detection value to an internal cache queue or memory data structure for subsequent processing calls.

Through the above method steps, the misjudgment caused by a single abnormal fluctuation can be avoided, and it can be used for sliding window analysis and water level trend identification.

Optionally, the step of comparing the reference capacitance value with the real-time detection capacitance value in water to determine a current water level state in the target water dispenser further includes: calculating differential values between the real-time detection values of the water capacitance and the reference capacitance values in multiple preset periods to obtain multiple capacitance differential values; determining that the target pet water dispenser is in the watery state when the capacitance differential values in the continuous preset number periods are greater than or equal to the reference capacitance value; and determining that the target pet water dispenser is in the waterless state when the capacitance differential values in the continuous preset number periods are less than the reference capacitance value.

In the embodiment of the present invention, the differential values calculation can be performed by subtracting the real-time detection capacitance value in water collected each time from the reference value under the initial no-load state to obtain a deviation amount that reflects the water level states.

The capacitance differential value may be a result value of the differential value calculation in each detection period, representing “variation amplitude” of the current water capacitance state relative to the reference value. Generally, it can be used to construct continuous state determination and serve as an input signal for the “water level state judgment logic”. Additionally, it can participate in additional functions such as fluctuation analysis and jitter recognition.

In one possible embodiment, after collecting the real-time detection capacitance value in water in each period, the difference between the value and the reference capacitance value stored in the device in the waterless state is calculated. The differences of the water capacitance in multiple consecutive periods can be used as the basis for judgment. If all the differences exceed the preset judgment threshold, they are judged to be in the watery states. If any difference does not reach the threshold, it is judged to be in the waterless state.

The multi-cycle differential value judgment mechanism can effectively mitigate the impact of fluctuation noise and significantly enhance the accuracy of water level determination.

Optionally, the step of comparing the reference capacitance value with the real-time detection capacitance value in water to determine a current water level state in the target water dispenser further includes: determining current environmental data of the water capacitance, wherein the environmental data includes temperature data and humidity data; determining an error adjustment data for the real-time detection capacitance value in water based on the temperature data and the humidity data; adjusting the real-time detection capacitance value in water based on the error adjustment data to obtain a target real-time detection capacitance value in water; and comparing the target real-time detection capacitance value in water with the reference capacitance value to obtain the current water level state in the target pet water dispenser.

In the embodiment of the present invention, the environmental data may include, but is not limited to, the temperature data and the humidity data. Specifically, these may be current external or internal physical environmental parameters collected by temperature and humidity sensors during the operation of the target pet water dispenser. It should be understood that environmental conditions will affect the capacitance value, thereby affecting the judgment of presence or absence of the water. For example, high humidity may lead to residual moisture on the electrode surface, while high temperature can alter the dielectric constant of materials. Additionally, temperature drift may cause ADC deviation or circuit noise.

The error adjustment data may be a capacitance correction value calculated based on the environmental data, used to compensate for deviations caused by environmental variations. Specifically, the error adjustment data can be determined according to the following compensation function:

$$Δ C\_env = a \times ( T - T 0 ) + b \times ( H - H 0 ) ;$$

Among them, T/H represents the current temperature and humidity, T0/H0 represents the standard temperature and humidity (such as 25° C., 50%), and a/b are empirical compensation coefficients (e.g., a =0.15 pF/° C., b=0.08 pF/% RH).

In one possible embodiment, the corresponding error compensation data is determined by the above compensation function and used to adjust the real-time detection capacitance value in water. After the adjustment, the final real-time detection value of the target water capacitance is obtained, which serves as the data for comparison with the reference value.

Specifically, while collecting the real-time detection capacitance value in water, the current temperature and humidity data are simultaneously read to form the environmental data. Based on this environmental data, the capacitance error adjustment data is calculated, and the originally collected water capacitance value is compensated and adjusted to obtain the target real-time detection capacitance value in water. Subsequently, the target water capacitance real-time detected value is compared with the reference value for further processing, thereby improving the accuracy of the water level detection in extreme environments (e.g., high temperature and humidity) and reducing the misjudgment rate.

Optionally, the step of controlling and managing an operation state of a water pump of the target pet water dispenser based on the water level state includes: controlling the water pump to start operation when the water level state remains in the waterless state for continuous multiple sampling periods; and controlling the water pump to stop operation when the water level state persists in the watery state for continuous multiple sampling periods.

In the embodiment of the present invention, a multi-cycle state confirmation mechanism is introduced to control the operation state of the water pump. Specifically, When the water level state is determined to be waterless in continuous multiple detection cycles, the pump is controlled to start operation. Conversely, when the water level is determined to be watery in continuous multiple detection cycles, the pump is controlled to stop operation. For example, as shown in Table 1 below:

| Period | water capacitance | differential | Judgement |
|---|---|---|---|
| number | value (pF) | value (pF) | state |
| T1 | 37.0 | 7.0 | Waterless |
| T2 | 36.8 | 6.8 | Waterless |
| T3 | 37.5 | 7.5 | Waterless |

When it is determined to be in the waterless for three consecutive cycles, the water pump is controlled to start operation. Other scenarios where the state is determined to have water are similar and will not be repeated further.

Through the above strategy, the fluctuation signal and instantaneous misjudgment can be effectively filtered, preventing the water pump from frequent switching due to false triggers, thereby improving the control accuracy and equipment stability.

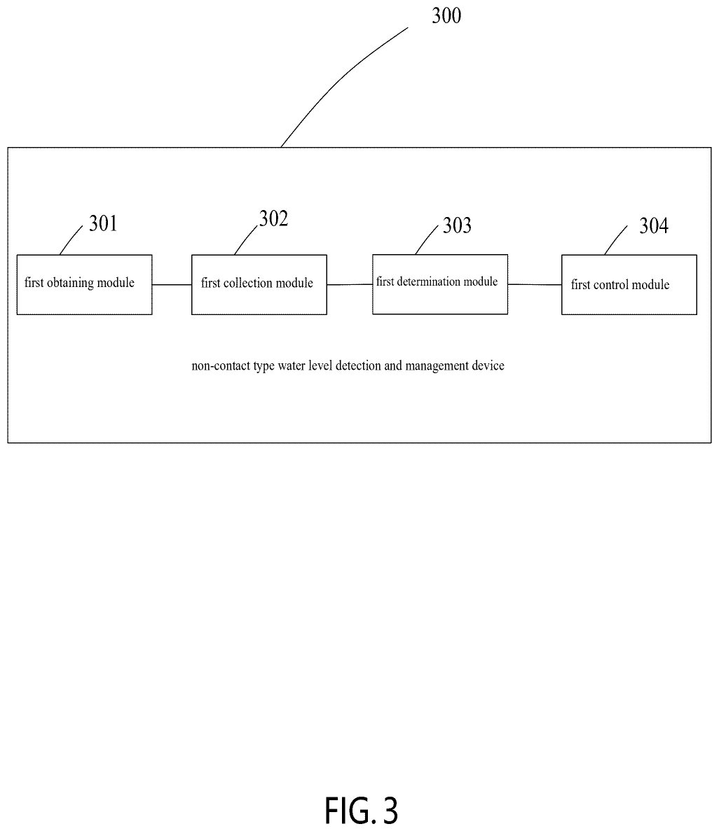

As shown in FIG. 3, the embodiment of the present invention further provides a non-contact type water level detection and management device 300. The non-contact type water level detection and management device 300 comprises:
a first obtaining module 301, used for obtaining a reference capacitance value of a target pet water dispenser in a waterless state;
a first collection module 302, used for collecting a real-time detection capacitance value in water of the target pet water dispenser at preset intervals during regular operation of the target pet water dispenser;
a first determination module 303, used for comparing the reference capacitance value with the real-time detection capacitance value in water to determine a current water level state in the target water dispenser; and
a first control module 304, used for controlling and managing an operation state of a water pump in the target pet water dispenser based on the water level state.

Optionally, the first obtaining module 301 further includes:
a first collection sub-module, used for grounding a preset test contact before the target pet water dispenser is powered up for the first time; and collecting a water capacitance value of the target pet water dispenser in the waterless state;
a storage sub-module, used for storing the water capacitance value of the target pet water dispenser in the waterless state as the reference capacitance value.

Optionally, the device further comprises:
a first determination sub-module, used for determining a first preset period based on detection interval data of the target pet water dispenser;
a second determination sub-module, determining a fluctuation state of a water capacitance of the target pet water dispenser, wherein the fluctuation state is used to determine a contact frequency between the water capacitance and a water level;
a third determination sub-module, used for determining adjustment data of the preset intervals based on the fluctuation state;
a fourth determination sub-module, used for adjusting the first preset period based on the adjustment data to obtain a second preset period; and
a real-time collection sub-module, used for collecting the real-time detection capacitance value in water of the target pet water dispenser according to the second preset period.

Optionally, the first collection module 302 includes:
a period detection sub-module, used for collecting the real-time capacitance value in water according to time interval data corresponding to the preset intervals when it is detected that the target pet water dispenser operates regularly, and buffering the collected real-time water capacitance values.

Optionally, the first determination module 303 includes:
a calculation sub-module, used for calculating differential values between the real-time detection values of the water capacitance and the reference capacitance values in multiple preset periods to obtain multiple capacitance differential values;
a fifth determination sub-module, used for determining that the target pet water dispenser is in the watery state when the capacitance differential values in the continuous preset number periods are greater than or equal to the reference capacitance value; and
a sixth determination sub-module, used for determining that the target pet water dispenser is in the waterless state when the capacitance differential values in the continuous preset number periods are less than the reference capacitance value.

Optionally, the device further comprises:
a seventh determination sub-module, used for determining current environmental data of the water capacitance, wherein the environmental data includes temperature data and humidity data;
an eighth determination sub-module, used for determining an error adjustment data for the real-time detection capacitance value in water based on the temperature data and the humidity data;
an adjustment sub-module, used for adjusting the real-time detection capacitance value in water based on the error adjustment data to obtain a target real-time detection capacitance value in water; and
a processing sub-module, used for comparing the target real-time detection capacitance value in water with the reference capacitance value to obtain the current water level state in the target pet water dispenser.

Optionally, the first control module 304 includes:
a first control sub-module, used for controlling the water pump to stop operation when the water level state persists in the watery state for continuous multiple sampling periods.
a second control sub-module, used for controlling the water pump to stop operation when the water level state persists in the watery state for continuous multiple sampling periods.

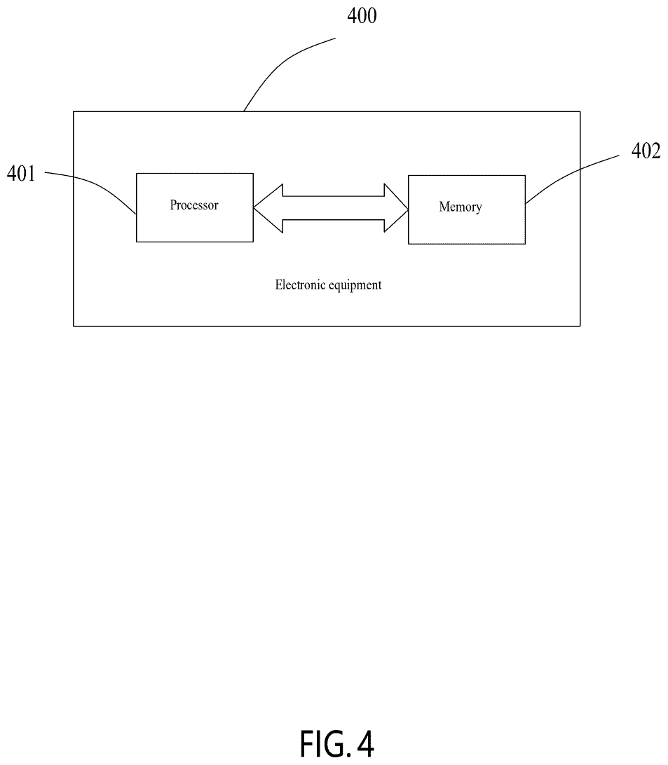

As shown in FIG. 4, the embodiment of the present invention further provides an electronic equipment 400, which comprises a processor, wherein the processor can perform any of the aforementioned non-contact type water level detection and management methods.

Specifically, the electronic equipment 400 comprises a processor 401 and a memory 402, and a computer program stored in the memory 402 and executed by the processor 401 to implement the non-contact type water level detection and management method.

The processor 401 executes the computer program of the non-contact type water level detection and management method stored in the memory 402, and performs the following steps:
obtaining a reference capacitance value of a target pet water dispenser in a waterless state;
collecting a real-time detection capacitance value in water of the target pet water dispenser at preset intervals during regular operation of the target pet water dispenser;
comparing the reference capacitance value with the real-time detection capacitance value in water to determine a current water level state in the target water dispenser; and
controlling and managing an operation state of a water pump in the target pet water dispenser based on the water level state.

Optionally, the processor 401 performs the step of obtaining a reference capacitance value of a target pet water dispenser in a waterless stat, including:
grounding a preset test contact before the target pet water dispenser is powered up for the first time; and collecting a water capacitance value of the target pet water dispenser in the waterless state; and
storing the water capacitance value of the target pet water dispenser in the waterless state as the reference capacitance value.

Optionally, before the processor 401 performs the step of, before collecting a real-time detection capacitance value in water of the target pet water dispenser at preset intervals during regular operation of the target pet water dispenser, the method further includes:
determining a first preset period based on detection interval data of the target pet water dispenser;
determining a fluctuation state of a water capacitance of the target pet water dispenser, wherein the fluctuation state is used to determine a contact frequency between the water capacitance and a water level;
determining adjustment data of the preset periodicity based on the fluctuation state;
adjusting the first preset period based on the adjustment data to obtain a second preset period; and
collecting the real-time detection capacitance value in water of the target pet water dispenser according to the second preset period.

Optionally, the processor 401 performs the step of collecting a real-time detection capacitance value in water of the target pet water dispenser at preset intervals during regular operation of the target pet water dispenser, including:
collecting the real-time capacitance value in water according to time interval data corresponding to the preset intervals when it is detected that the target pet water dispenser operates regularly, and buffering the collected real-time water capacitance value.

Optionally, the processor 401 is further configured to determine the water level state, wherein the water level state includes a watery state and a waterless state; wherein comparing the reference capacitance value with the real-time detection capacitance value in water to determine a current water level state in the target water dispenser includes:
calculating differential values between the real-time detection values of the water capacitance and the reference capacitance values in multiple preset periods to obtain multiple capacitance differential values;
determining that the target pet water dispenser is in the watery state when the capacitance differential values in the continuous preset number periods are greater than or equal to the reference capacitance value; and
determining that the target pet water dispenser is in the waterless state when the capacitance differential values in the continuous preset number periods are less than the reference capacitance value.

Optionally, the processor 401 is further configured to perform the step of comparing the reference capacitance value with the real-time detection capacitance value in water to determine a current water level state in the target water dispenser, the method further includes:
determining current environmental data of the water capacitance, wherein the environmental data includes temperature data and humidity data;
determining an error adjustment data for the real-time detection capacitance value in water based on the temperature data and the humidity data;
adjusting the real-time detection capacitance value in water based on the error adjustment data to obtain a target real-time detection capacitance value in water; and
comparing the target real-time detection capacitance value in water with the reference capacitance value to obtain the current water level state in the target pet water dispenser.

Optionally, the processor 401 is further configured to perform the step of controlling and managing an operation state of a water pump of the target pet water dispenser based on the water level state, including:
controlling the water pump to start operation when the water level state remains in the waterless state for continuous multiple sampling periods; and
controlling the water pump to stop operation when the water level state persists in the watery state for continuous multiple sampling periods.

The embodiment of the present invention further provides a computer readable storage medium, wherein the computer readable storage medium stores a computer program. When the computer program is executed by the processor, various steps of the non-contact type water level detection and management method provided by the embodiment of the present invention or the non-contact type water level detection and management method at the application end can be implemented, and the same technical effects can be achieved. For conciseness, redundant descriptions are omitted here.

Ordinary technicians in this field can understand that all or part of the process of implementing the above implementation example method. It is a program that can be completed by a computer program instructing relevant hardware, and can be stored in a computer readable storage medium. When the computer program is executed, it may include the process of implementing examples such as the above methods. The storage medium may be a magnetic disk, an optical disc, a Read-Only Memory (ROM), a Random Access Memory (RAM), etc.

The aforementioned disclosures only represent the preferred embodiments of the present invention and certainly cannot be used to limit the scope of the patent rights of the present invention. Therefore, equivalent variations made in accordance with the claims of the present invention are still within the scope of the present invention.

1. A non-contact type water level detection and management method, comprising:
obtaining a reference capacitance value of a target pet water dispenser in a waterless state;
collecting a real-time detection capacitance value in water of the pet water dispenser at preset intervals during regular operation of the pet water dispenser;
comparing the reference capacitance value with the real-time detection capacitance value in water to determine a current water level state in the water dispenser; and
controlling and managing an operation state of a water pump in the pet water dispenser based on the water level state.

2. The non-contact type water level detection and management method according to claim 1, wherein obtaining a reference capacitance value of a target pet water dispenser in a waterless state includes:
grounding a preset test contact before the pet water dispenser is powered up for the first time; and collecting a capacitance value of the pet water dispenser in the waterless state; and
storing the capacitance value of the pet water dispenser in the waterless state as the reference capacitance value.

3. The non-contact type water level detection and management method according to claim 1, wherein, before collecting a real-time detection capacitance value in water of the pet water dispenser at preset intervals during regular operation of the pet water dispenser; the method further comprises:
determining a first preset period based on detection interval data of the pet water dispenser;
determining a fluctuation state of a capacitance in water of the pet water dispenser, wherein the fluctuation state is used to determine a contact frequency between the capacitance in water and a water level;
determining adjustment data of the preset intervals based on the fluctuation state;
adjusting the first preset period based on the adjustment data to obtain a second preset period; and
collecting the real-time detection capacitance value in water of the pet water dispenser according to the second preset period.

4. The non-contact type water level detection and management method according to claim 1, wherein collecting a real-time detection capacitance value in water of the pet water dispenser at preset intervals during regular operation of the pet water dispenser includes:
collecting the real-time capacitance value in water according to time interval data corresponding to the preset intervals when it is detected that the pet water dispenser operates regularly, and buffering the collected real-time capacitance value in water.

5. The non-contact type water level detection and management method according to claim 1, wherein the water level state includes a watery state and a waterless state; wherein comparing the reference capacitance value with the real real-time detection capacitance value in water to determine a current water level state in the water dispenser includes:
calculating differential values between the real-time capacitance detection values in water and the reference capacitance value in multiple preset periods to obtain multiple capacitance differential values;
determining that the pet water dispenser is in the watery state when the capacitance differential values in the continuous preset number periods are greater than or equal to the reference capacitance value; and
determining that the pet water dispenser is in the waterless state when the capacitance differential values in the continuous preset number periods are less than the reference capacitance value.

6. The non-contact type water level detection and management method according to claim 5, wherein comparing the reference capacitance value with the real-time detection capacitance value in water to determine a current water level state in the water dispenser further includes:
determining current environmental data of the capacitance in water, wherein the environmental data includes temperature data and humidity data;
determining an error adjustment data for the real-time detection capacitance value in water based on the temperature data and the humidity data;
adjusting the real-time detection capacitance value in water based on the error adjustment data to obtain a target real-time detection capacitance value in water; and
comparing the target real-time detection capacitance value in water with the reference capacitance value to obtain the current water level state in the pet water dispenser.

7. The non-contact type water level detection and management method according to claim 5, wherein controlling and managing an operation state of a water pump in the pet water dispenser based on the water level state includes:
controlling the water pump to start operation when the water level state remains in the waterless state for continuous multiple sampling periods; and
controlling the water pump to stop operation when the water level state persists in the watery state for continuous multiple sampling periods.

8. A non-contact type water level detection and management device, comprising:
a first obtaining module, used for obtaining a reference capacitance value of a target pet water dispenser in a waterless state;
a first collection module, used for collecting a real-time detection capacitance value in water of the pet water dispenser at preset intervals during regular operation of the pet water dispenser;
a first determination module, used for comparing the reference capacitance value with the real-time detection capacitance value in water to determine a current water level state in the water dispenser; and
a first control module, used for controlling and managing an operation state of a water pump in the pet water dispenser based on the water level state.

9. An electronic equipment, comprising: a memory, a processor, and a computer program stored in the memory and executed by the processor, wherein when the processor executes the computer program, the steps of the non-contact type water level detection and management method according to claim 1 are implemented.
